(19) United States
(12) Patent Application Publication
(10) Pub. No.: US 2023/0196469 A1
(43) Pub. Date: Jun. 22, 2023

(54) System and Method for Processing Insurance Cards

(71) Applicant: Get Heal, Inc., Los Angeles, CA (US)

(72) Inventors: Vikash Singh, Los Angeles, CA (US); Suraj Arun Vathsa, Irvine, CA (US); Brian Kohler, Santa Monica, CA (US); Salvatore Nuziale, Playa Vista, CA (US)

(73) Assignee: Get Heal, Inc., Los Angeles, CA (US)

(21) Appl. No.: 17/554,837

(22) Filed: Dec. 17, 2021

(51) Int. Cl. G06Q 40/08; G06V 30/19

(52) U.S. Cl. CPC G06Q 40/08; G06V 30/1916

(57) ABSTRACT

A system and method processes images of insurance cards to extract information. The images of the insurance cards are processed using OCR to identify characters on the insurance cards. Combinations of characters on each insurance card are identified as tokens, and their relative spatial orientation is determined. Deep learning architectures are utilized to generate a fully connected neural network with a node for each token on each card. The neural network is utilized to extract entities from each insurance card, such as a valid member ID.

### FIELD OF THE TECHNOLOGY

The subject disclosure relates to automatically processing data, and more particularly, systems and methods for automatically processing information from insurance cards.

### BACKGROUND OF THE TECHNOLOGY

Informational cards, such as credit cards, gift cards, insurances cards, and the like are widely used for a variety of purposes. In some circumstances, it can be advantages to extract information from these cards quickly and automatically. There are some options currently for doing so. For example, many smartphones are able to take a picture of a credit card and process the image to identify a credit card number and date. Smartphones are able to do this for credit cards, because credit cards typically always show the same information in a similar format (e.g. a 12 digit credit card number.

While this technology is available for credit cards, it becomes much more challenging to extract information from cards which do not have set predetermined information or formats. This is a particular problem with insurance cards, where different payors may use insurance cards with much different formats, and with more or less data about the insurance plan and the insured. Further, existing technology is not designed to recognize errors when a piece of information is misidentified, or automatically modify its processes to obtain better accuracy in the future. Therefore there is a need for a system and method of processing cards, such as insurance cards, which accurately processes data about a card and adaptively changes based on feedback.

### SUMMARY OF THE TECHNOLOGY

In light of the needs described above, in at least one aspect, the subject technology relates to a system for processing a plurality of images of insurance cards to extract entities, the system having at least one computer-readable medium storing instructions, which, when executed carries out the following steps. Images of the insurance cards are processed using OCR to identify characters on the insurance cards and relative spatial orientation of said characters to determine a plurality of tokens and a spatial orientation of said tokens, the tokens representing possible combinations of identified characters on the insurance card. Coordinates are determined for each token on the insurance card based on the spatial orientation of the tokens, the tokens and coordinates representing an OCR output. A fully connected neural network is generated including a node for each token based on the images of the insurance cards and the OCR output. Each node is scored with a member ID score for the likelihood that said node corresponds to a member ID on the insurance card. On each insurance card, a member ID for said insurance card is identified based on the node with the highest member ID score.

In some embodiments, generating the fully connected neural network includes modeling the OCR output for each insurance card by using vector representations of each token. In some embodiments, generating the fully connected neural network includes generating a graph based on the OCR output for each insurance card, with each token for said insurance card taken as a node of the graph and edges being declared when Euclidean distance is below a given threshold. A node feature matrix is constructed based on the graph and each node is scored based, at least in part, on the node feature matrix.

In at least one aspect, the subject technology relates to a system for processing a plurality of insurance cards. The system includes a camera configured to capture a plurality of images, the images including one image corresponding to each one of the insurance cards. The system also includes at least one computer configured, for each insurance card, to do the following. The at least one computer processes the image of the insurance card using OCR to identify characters on the insurance card and relative spatial orientation of said characters to determine a plurality of tokens and a spatial orientation of said tokens, the tokens representing possible combinations of identified characters on the insurance card. The at least one computer determines coordinates for each token on the insurance card based on the spatial orientation of the tokens. The at least one computer executes a first processing step based on a first recurrent neural network (RNN), or RNN variant, to model the OCR output for each insurance card using vector representations of each token to obtain a logit for each token. The at least one computer executes a second processing step based on a graph neural network (GNN), or GNN variant, including generating embeddings based on an RNN output from the first RNN, the embeddings being vector representations of the tokens, and using the embeddings and the OCR output to generate a graph, with each token as a node, to construct a node feature matrix. The at least one computer executes a third processing step using a hybrid convolutional neural network (CNN), the hybrid CNN processing the image of each insurance card with a CNN to generate an image representation of each insurance card and combining each image representation with a hidden output from the first RNN. The at least one computer executes a fourth processing step using a second RNN, or RNN variant, the second RNN modeling the OCR output using a fixed length vector from the image of the insurance card. The at least one computer extracts at least one entity from each insurance card based on the processing steps by assigning a score to the tokens based on a likelihood that the token corresponds to an expected characteristic, the expected characteristics including at least a member ID.

In some embodiments, when executing the second processing step, edges define connections between nodes on the graph when a Euclidean distance between said nodes exceeds a predetermined threshold. In some embodiments, each processing step generates at least one logit for each token correlating said token to with one of a plurality of expected characteristics. Further, during the step of extracting the at least one entity, the score for each entity can be assigned to each token based on the logits correlating said token to one of the expected characteristics.

In some embodiments, the at least one computer is further configured to train the system during the processing steps by executing the processing steps on insurance cards comprising: a first group of insurance cards representing a validation set; a second group of insurance cards representing a training set. In some cases, the at least one computer further includes a database of predetermined payer labels. Further, for each insurance card, the system can determine a payer associated with said insurance card by processing the image of said insurance card and ranking a likelihood of each payer based on the database of predetermined payer labels.

In some embodiments, the system further determines the payer with the CNN during execution of the third processing step. In some cases, the system is further configured to generate a database of information for a plurality of members each associated with one of the insurance cards, the database registering one member for each insurance card and including at least a name and member ID for each member based on the entities extracted for said insurance card.

In some embodiments the expected characteristics further include one or more of the following: a name; and an insurance company. In some cases, during execution of the second processing step, hybrid backpropagation is used to train the GNN and RNN collaboratively. In some embodiments, during execution of the third processing step, the CNN and first RNN are joined and the parameters of the CNN and first RNN are updated simultaneously to optimize train the hybrid CNN.

### BRIEF DESCRIPTION OF THE DRAWINGS

So that those having ordinary skill in the art to which the disclosed system pertains will more readily understand how to make and use the same, reference may be had to the following drawings.

FIG. 1 is a block diagram of an exemplary system for processing an insurance card in accordance with the subject technology.

FIG. 2 is a block diagram of a deep learning module of the system.

FIG. 3 is a block diagram of an exemplary recurrent neural network (RNN) architecture which can be utilized by the system.

FIG. 4 is a block diagram of a hybrid graph neural network (GNN) architecture which can be utilized by the system.

FIGS. 5-6 are block diagrams of a hybrid convolution neural network (CNN) architecture which can be utilized by the system.

FIG. 7 is a block diagram of a combination of an exemplary RNN based architecture and raw image data which can be utilized by the system.

FIG. 8 is a block diagram of a ranked payer suggestion method which can be executed by the system.

FIG. 9 is a block diagram of the flow of information through a second system for training and executing the processes of the system of FIG. 1.

### DETAILED DESCRIPTION

The subject technology overcomes many of the prior art problems associated with registering insurance information for new member patients. In brief summary, the subject technology provides a system and method for assessing an insurance card and accurately extracting relevant information. The advantages, and other features of the systems and methods disclosed herein, will become more readily apparent to those having ordinary skill in the art from the following detailed description of certain preferred embodiments taken in conjunction with the drawings which set forth representative embodiments of the subject technology.

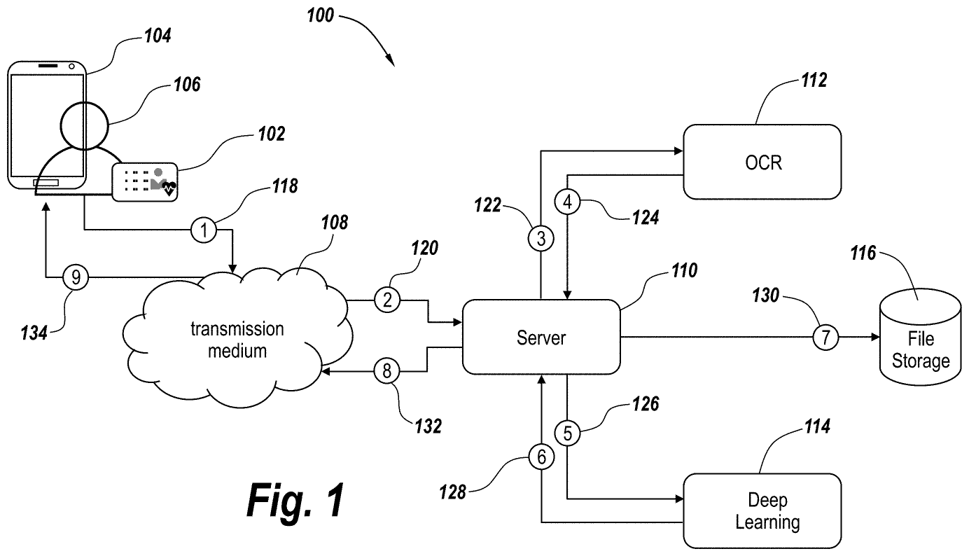

Referring now to FIG. 1, a block diagram of an exemplary system 100 in accordance with the subject technology is shown. In brief summary, the system 100 carries out a fully automated process to extract entities (i.e. data points such as name, card number, and insurance company) from insurance cards 102 by a device 104 connected to the internet and utilizing an integrated camera. When onboarding a patient onto a software platform that facilitates the delivery of medical care, the patient ordinarily needs to manually enter information. Automatic extraction of information from the insurance card can save time and improve accuracy in entering information about the cardholder (i.e. the patient, or member). Therefore, automatic extraction of specific entities from insurance cards, including and not limited to the payer name, patient name, date of birth, and member identification constitutes an important task to increase the efficiency in onboarding patients onto a software platform that facilitates the delivery of medical care.

This system 100 is configured to process a raw image of the insurance card 102, which can be captured by a device 104 equipped with a camera, such as a smartphone of a user. The captured image can then be received at the server 110 via an API call made by the device 104 (i.e. through a transmission medium 108 such as an edge device). The system 100 then goes through a process of extracting the information/tokens along with the spatial information using optical character recognition (OCR) software (i.e. through OCR module 112). Notably, the term “tokens” is used herein to describe data points representing the various combinations of characters in the image of the insurance card. The system 100 then employs deep learning (i.e. deep learning module 114) to derive meaning from tokens that have been extracted from the insurance card 102. The identified entities of interest, along with other relevant metadata, can be stored (i.e. at file storage 116), and returned to the device 104 when the device 104 requests this information after a predefined amount of time, or as a response directly to the API call made by the device 104.

For capturing tokens from the insurance card 102 at OCR module 112, off-the-shelf or in-house optical character recognition systems can be employed. These tokens, their spatial information, and the pixel values of the raw image itself serve as multimodal inputs to the deep learning module 114 of the system 100. Several different deep learning architectures can be used, including multimodal architectures which simultaneously process the tokens (character sequences) coming out of the OCR system 112 in addition to the raw image itself. It should be understood that while various components of the system are referred to as modules, servers, or other computer components, this is for ease of explanation only. The individual components of the system 100 can be carried out using one or more computer-readable mediums which include instructions for carrying out the processes described herein.

FIG. 1 also shows the steps of one exemplary method of processing an insurance card in accordance with the subject technology. First, the user 106 takes a picture of their insurance card 102. The image of the card 102 is sent, at step 118, through the transmission medium 108, and then transmitted to the server 110 at step 120. The server 110 can then save the image, before forwarding the image to the OCR module 112 at step 122. The OCR module 112 is tasked with generating text tokens from the image. This can be accomplished by assessing every possible combination of characters within a predetermined distance of one another on the insurance card (i.e., ignoring combinations of characters that are too far apart). The OCR output includes actual text tokens and their locations on the insurance card 102. The OCR module 112 then output text tokens of the image and return the tokens back to the server 110 at step 124. The server 110 can then optionally save the OCR output, and forward the OCR output to the deep learning module 114 at step 126. Alternatively, the OCR module 112 can interface directly with the deep learning module 114, transferring the OCR output directly thereto.

The deep learning module 114 then performs inference and to generate a prediction output for information of interest on the card 102 using both the raw image of the insurance card 102 and the OCR output (text tokens and their locations) and returns the prediction output to the server at step 128. This process is discussed in more detail below. The server 110 can then (if it has not already) save the raw image, OCR output, and prediction output to file storage 116, at step 130. This can then serve as a dataset for enhancing the deep learning models or to implement a re-training pipeline.

At step 132, the server 110 then returns the prediction output to the device 104 through the transmission medium 108. The device 104 then receives the prediction output and can choose to use it for display or further processing. Ultimately, the system 100 scores various tokens found on insurance card for a correlation to various expected characteristics on the insurance card, such as an insurance payer, member ID, or the like, and extracts an entity based on the highest correlation score.

The actions carried by the OCR module 112 are now discussed in more detail. After the device 104 has uploaded the image of the raw insurance card 102, the OCR module 112 uses OCR to obtain text tokens and their respective spatial orientations, including but not limited to the relative coordinates of the bounding box that surrounds each token, that are present on the card 102. The text tokens, the spatial information of each of these tokens, and the pixel values of the image serve as input to the deep learning component of our system. The OCR output includes two main output points. The first is all identified text tokens for the given image of the insurance card 102. The second is the spatial information for each token, which can be used to derive relative position of each token on insurance card within an insurance card coordinate system. Various OCR systems, as are known in the art, can be utilized to help carry out the functions of the OCR module 112 described above. For example, systems such as Tesseract, Amazon Rekognition, and Google Cloud Vision can be utilized.

The actions of the deep learning module 114 are now discussed in more detail. The deep learning module 114 is invoked after the OCR module 112. The deep learning module 114 can support multiple architectures, as outlined below. It is important to note that each architecture described for this entity extraction task outputs a logit per token extracted which is correlated with the likelihood of that token being a member ID. The end to end pipeline involves performing inference (potentially in parallel processes/threads) on all extracted tokens for a given image and identifying the member ID as the token in the entire set with the highest member ID score. Notably, while member ID is used as one example of information gleaned from the insurance card 102, it should be understood that other information can also be obtained. For example, insurance cards can be expected to contain various information about the card holder, or member, to whom the card belong. Other characteristics, such as a payer name, date of birth, plan type, or other information, can also be obtained by scoring tokens based on the likelihood that they pertain to a different expected characteristic.

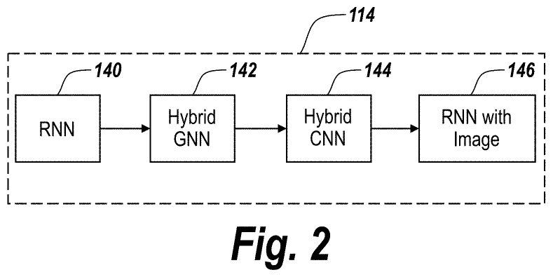

Referring now to FIG. 2, exemplary deep learning architectures that can be carried out by the deep learning module 114 as part of the system 100 are shown. As will be discussed in more detail below, the deep learning module 114 can first utilize a recurrent neural network 140 (RNN) architecture. Next, a hybrid approach using a graph neural network (GNN) architecture and RNN architecture is utilized. Next, a hybrid convolutional neural network (CNN) and RNN architecture is utilized. Finally, an RNN architecture is combined with image features of the insurance card 102, and without CNN. Each of these architectures represent exemplary architectures which can be carried out individually, independently, and/or in conjunction with one another to process the information on the insurance card 102.

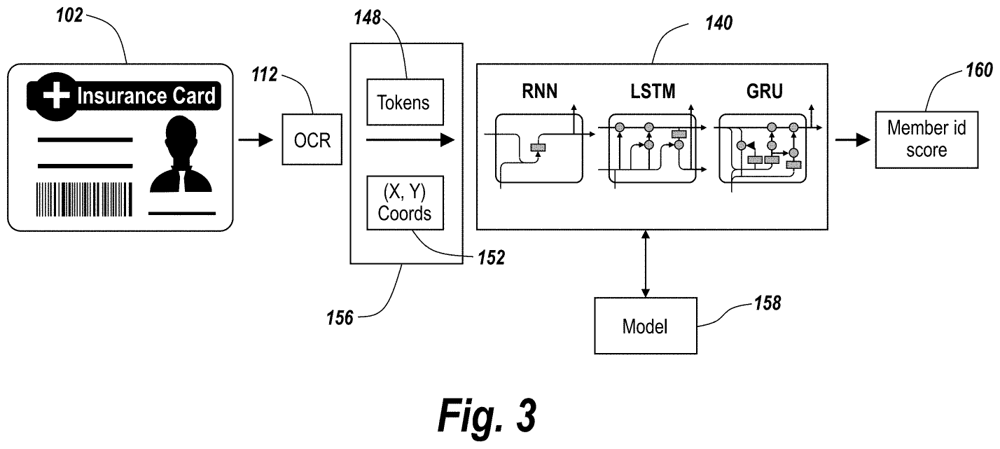

Referring now to FIG. 3, an example of an RNN architecture 140 which can be utilized by the deep learning module 114 is shown. Notably, while the architecture 140 is referred to as an RNN architecture for brevity, as discussed in more detail below, other sequence classification architectures may also be used. As discussed above, the image of the insurance card 102 is processed using an OCR module 112. The OCR output 156 includes tokens 148 and coordinates 150 (e.g. x, y coordinates) indicating a spatial location of each token 148 on the insurance card 102. The OCR output 112 is then passed to the deep learning module 114 for further processing.

The deep learning module can utilize an RNN 140 that processes sequences of characters (tokens 148) and their spatial locations (coordinates 152) from the OCR output 156. More specifically, each individual token 148 from the OCR output 156 is modeled (e.g. model 158) as a sequence of characters in which the set of possible characters includes all letters of the alphabet and 0-9 numbers. The model 158 includes the task of target entity extraction as a sequence classification task, in which an RNN sequence classifier is applied to obtain a logit for each token 148. Traditional RNN architectures for sequence classification add several feed-forward layers after a hidden state output, ending with a final single node sigmoid layer. However, in the RNN process described herein, the relative coordinates 152 (in the x-y dimensions) of the token 148 on the insurance card 102 are appended to a hidden state before final classification with several fully connected layers, ending with a single neuron final layer with a sigmoid activation function to perform the final classification. The integration of spatial information allows the RNN to jointly process the sequence of characters in addition to their spatial information when making a decision.

While RNN is one advantageous neural network approach that can be implemented for sequence classification, alternative architectures can also be used in other cases (e.g. at block 140). For example, including but not limited to bidirectional RNNs, long short-term memory (LSTM) neural networks, and/or transformers. Bidirectional RNNs will utilize two RNN networks that process a given sequence in both the forwards and backwards directions. Ultimately this leads to two hidden states, which can be directly concatenated before further processing by fully connected layers. Long short-term memory (LSTM) neural networks are a variant of the RNN in which the gate structure is altered to allow gradients to flow without vanishing. Transformers are a neural network architecture that deviates from the typical recurrent structure of sequence processing to solely leverage attention mechanisms.

One of the goals of the system 100 in processing the insurance card 102 is to identify a member ID from the insurance card 102. In order to train the RNN for member ID extraction, the dataset creation process involves extracting a dataset consisting of both valid member ID tokens 148 extracted from an external database (not shown distinctly) and other tokens which are found across insurance cards which are not member IDs. This allows for clear label creation that is needed in order to train an RNN to discriminate between tokens which are valid member IDs, and those which are commonly found on insurance cards which are not valid member IDs. From this, a member ID score 160 can be extracted for each token 148, with the highest score being used to identify which token 148 on the insurance card 102 represents the true member ID. This dataset creation process can be repeated for any entity instead of member ID via the same process, and the architectures can be used to discriminate between tokens of that target entity and other tokens.

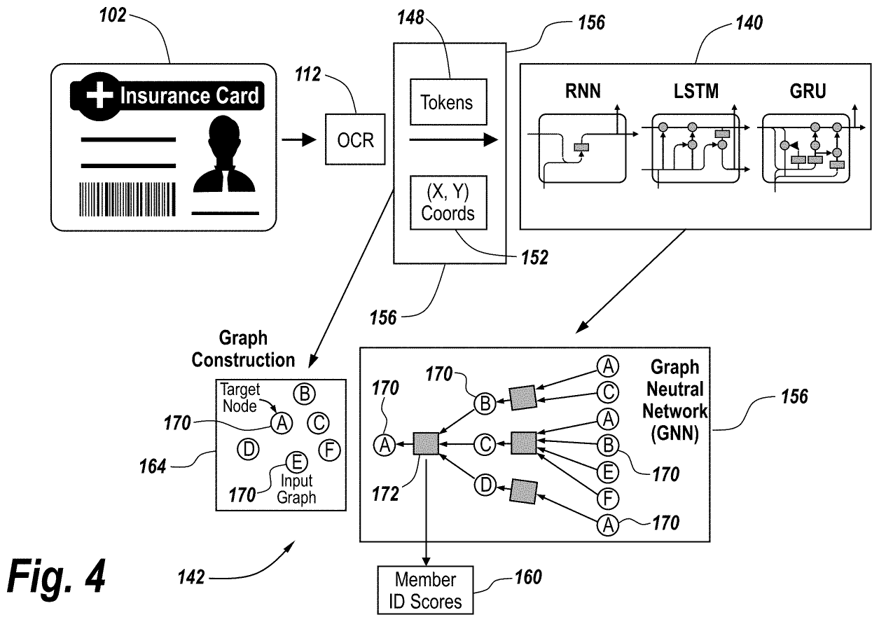

Referring now to FIG. 4, a block diagram of the deep learning process is shown in which the deep learning module 114 utilizes a hybrid graph neural network 142. The graph neural network has two components. The first sub-component 164 is the output from the RNN 140 (or alternative structure, as described above), in which a vector representation or embedding is produced for each token 148. The second sub-component 166 of the hybrid graph network 142 leverages the embeddings generated from the RNN 140, which are generated as described above, using a GNN architecture. The GNN 166 is configured to process information such as graphs and manifolds that do not exist in typical Euclidean vector spaces. In the present case, each token 148 processed is defined as a node 170 in the graph and an adjacency matrix is constructed for the graph representation by declaring an edge 172 between two nodes 170 if their Euclidean distance is below a given threshold. In one example, the threshold can be set at 2 cm, which has been found to be an effective default value. In other cases, the distance may be set at other distances, including a distance between 1-3 cm, such as 1 cm, 1.5 cm, 2.5 cm, 3 cm, or another distance in that range. In other cases, the distance itself can be a parameter that can be tuned to fined an optimal value during a given application. The node feature matrix is constructed using the RNN embeddings and the propagation of information performs an aggregation of the embeddings of the neighboring nodes 170, intuitively capturing both the information about the token 148 itself as well as what surrounds the token 148.

One type of GNN architecture that has been found to be advantageous when employed within the system 100 is a graph convolutional network (GCN). Other variants of GNN can also be used in place of the GCN to potentially improve the performance, including but not limited to, graph attention networks (GAT), graph isomorphism networks (GIN), and jumping Knowledge Networks (JK-Networks). In general, GAT is an architecture which leverages attention between neighboring nodes to weight the aggregation step. GIN is a known architecture which is as powerful as the Weisfeiler-Lehman (WL) graph isomorphism test. JK-Networks leverage combinations of node level representations across different GNN layers.

This hybrid GNN 142 architecture presents advantages over singular RNN and GNN architectures often where optimization occurs via gradient descent independently. By contrast, the hybrid GNN 142 uses RNN-based embeddings as features to a GNN aggregator which simultaneously trains both the RNN 140 and GNN 166 networks. Hybrid backpropagation compels the two networks to learn collaboratively for the final prediction task, which in this case is node classification with a classic cross entropy loss function. This approach, in which RNN 140 embeddings are fed into a GNN 166, is useful for integrating context about neighboring tokens into the prediction of a given token. GNNs are designed exactly for this utility so this hybrid approach allows the system 100 to process information about both the sequence of characters as well as the content of sequences within a given proximity. The output from the GNN 166 can be used to further revise the member ID scores 160 for the tokens 148 (and can similarly be used to score other tokens which may represent other information typically present on an insurance card 102).

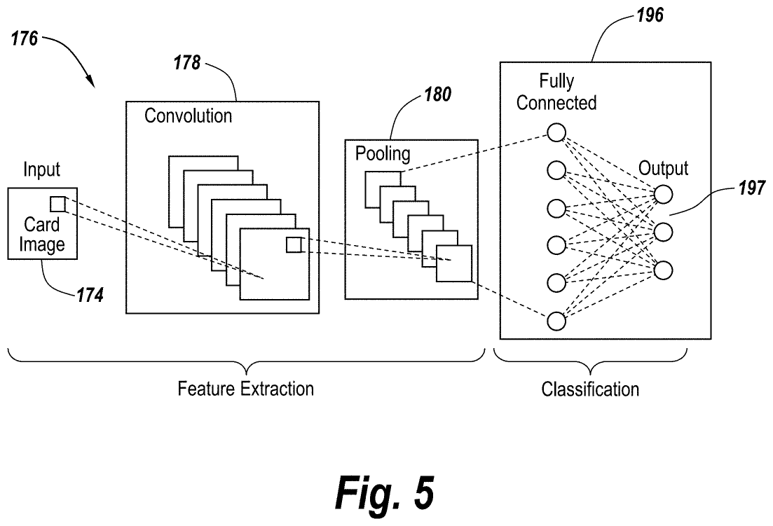

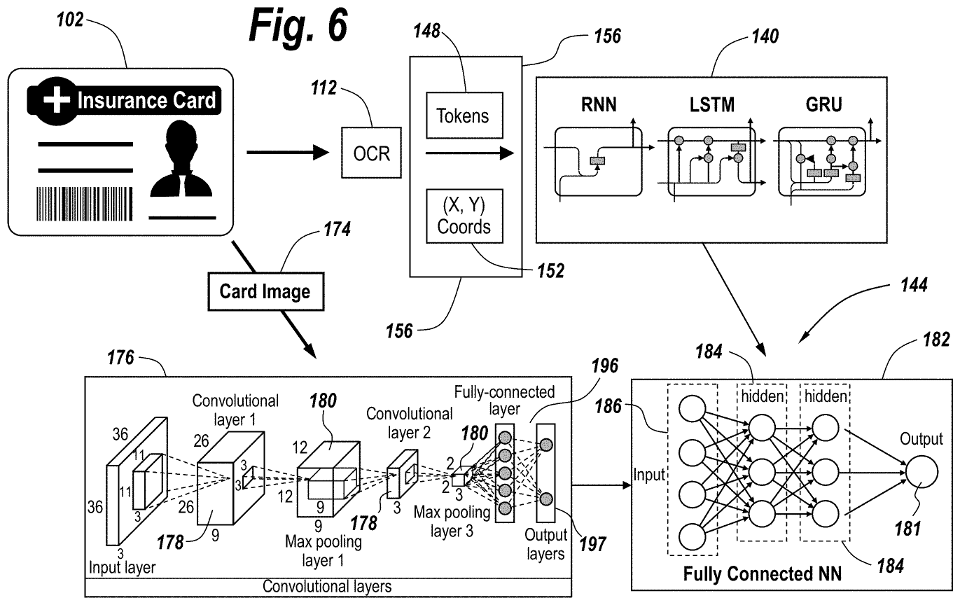

Referring now to FIGS. 5-6, a block diagram of the deep learning process is shown in which the deep learning module 114 utilizes a hybrid CNN architecture 144 using CNN 176 and RNN 140 architectures for processing a given token 148 and an entire image 174, respectively. The CNN 176 is shown isolated in FIG. 5 for clarity. While the dataset construction process for solely RNN architectures required only the tokens 148 themselves along with their spatial orientation (e.g. x. y. coordinates 152), this joint architecture (hybrid CNN architecture 144) also requires the original image 174 itself to be fed into the CNN 176. It is important to note that since a single image 174 contains many different tokens 148, the dataset will consist of repeated images, though the pairing of image and token will always remain unique for a given sample.

As shown in FIG. 6, the output from the RNN 140 serves as input into the hybrid CNN 144. More particularly, the hidden output 184 of the RNN 140 is combined with the image latent representation 186 obtained from an intermediate layer of the CNN 176 via direct concatenation. The RNN network leveraged can be the RNN 140, or variation, as described above with respect to RNN 140. The CNN architecture can be adapted from a simple LeNet architecture with several layers alternating between convolution layers 178 and pooling layers 180. After feature extraction from the convolution and pooling layers 178, 180, feature classification 196 of the card image 174 can be completed (as best shown on FIG. 5).

This hybrid CNN and RNN architecture used herein falls into the subset of deep learning known as multimodal deep learning, in which a task is solved through an architecture in which different modalities are processed by neural networks and subsequently integrated. The goal of multimodal deep learning is to improve predictive performance on a given task through integrating separate but important modalities for the prediction task. In this case, the system 100 leverages the fact that both the token 148 itself as well as the raw image 174 are both useful for the classification of a member ID (and other information) on the insurance card 102. Once the CNN 176 representation and the RNN 140 representation are combined the new representation is passed through several fully connected layers to make the final classification, ending with a single neuron 181 with a sigmoid activation to perform the final classification and form a fully connected neural network 182.

This hybrid CNN 144 approach, in which the system 100 separately processes the token 148 with an RNN 140 and the raw image 174 with a CNN 176, allows the system 100 to jointly consider the overall visual representation of the card 102 along with the given token 148 being processed. This positions the system 100 to be able to jointly learn relationships between the tokens 148 and images 174 in the context of extracting important information from the insurance card 102. While optimization of singular RNN and CNN architectures often occurs via gradient descent independently, this hybrid CNN architecture 144 comprises individual RNN 140 and CNN 176 networks that ultimately are joined and synthesized by latter layers of the neural network 182, and thus the parameter updates to both these neural networks (RNN 140 and CNN 176) occurs simultaneously.

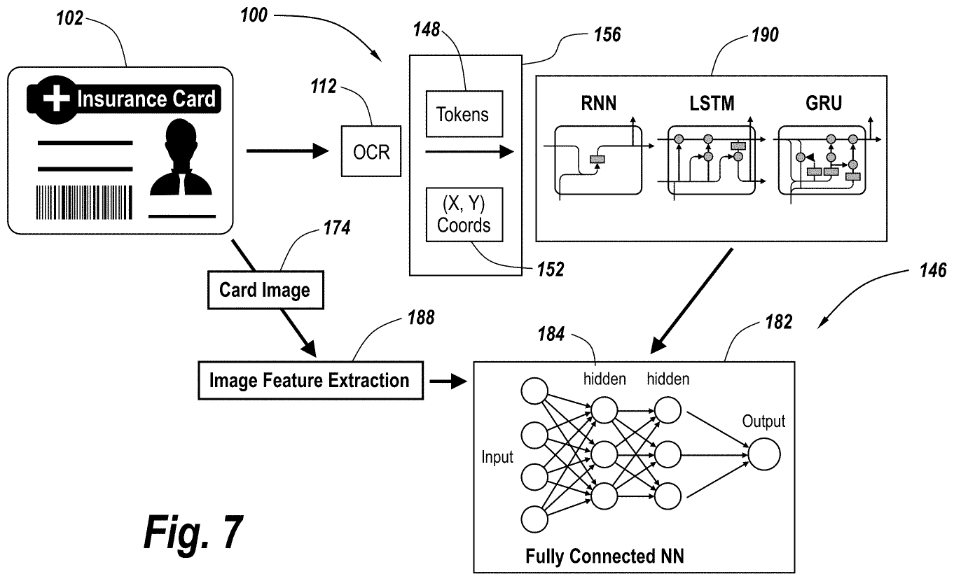

Referring now to FIG. 7, a final RNN based architecture 146 is shown from the deep learning module 114 which uses an RNN 190 to produce a representation of each token 148 that is combined with features extracted from the raw image 174 (e.g. feature extraction 188) of the insurance card 102 without using a CNN. The RNN based architecture 146 is similar to the hybrid CNN architecture 144 of FIG. 6, the difference being that that the image extraction feature 188 is used instead of the CNN 176. The image extraction feature 188 can be a filter, allowing for more efficient processing than when the CNN 176 is used.

In this scenario, the system 100 leverages an RNN architecture 190 to process both the sequence of characters that define each token 148 in addition to the relative cartesian coordinates 152 as part of a fully connected neural network 182 of the system 100. Unlike the first RNN 140, this RNN 190 is used to concatenate a fixed length feature vector which is constructed by processing the original image 174. This can be done in several ways including but not limited to: Harilack texture feature extraction, which is computed from a Gray Level Co-occurrence matrix (GLCM); or color feature extraction via binned histogram, which can ultimately be flattened to a fixed feature vector. A combination of color and texture can be used as well to get a more holistic feature of the given image. Unlike the multi-modal architecture with the CNN 176, this is lighter weight and has less trainable parameters, which can assist in stability of network training while still capturing visual information. Through the neural network 182, the system 100 identifies entities of interest, such as member ID or other member information present on the insurance card 102.

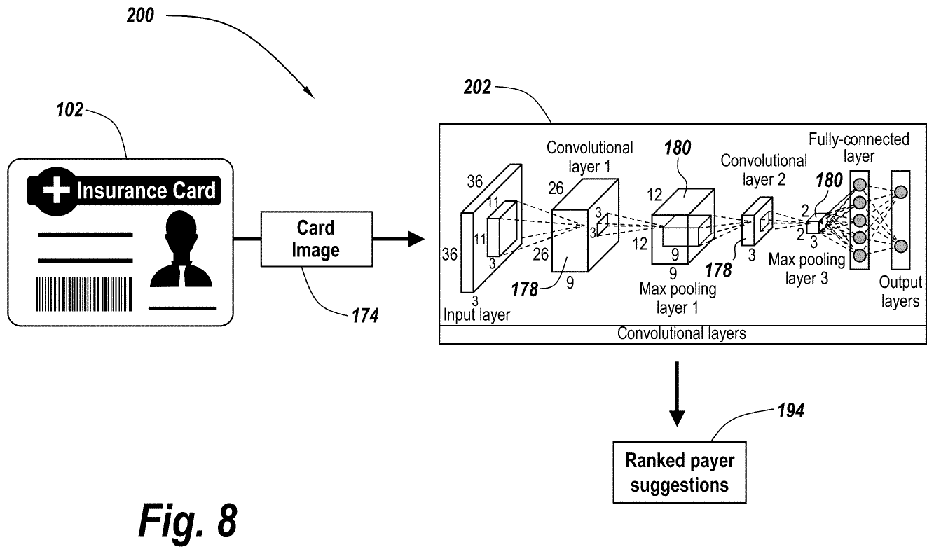

Referring now to FIG. 8, a block diagram of a ranked payer suggestion method 200, which can be executed by the system 100, is shown. As part of the method 200, a CNN 200 can also be used to obtain a ranked payer suggestion 194. The CNN 200 can be similar to the CNN 176, except as otherwise shown and described. Along with the desire to extract important entities once the insurance card 102 is ingested, automated payer classification of insurance cards 102 is also helpful during intake of a new insurance card 102 and/or member. This can be done using deep learning techniques, as discussed herein, to identify visual patterns present in the card 102 for image classification. Whereas traditional techniques in computer vision focused on manually engineered feature extraction using custom filters, deep learning can use large image datasets to break benchmarks on image classification tasks by learning filters through observation of many images. Therefore the system 100 leverage CNNs for the task of mapping a given image 174 of an insurance card 102 to a single payer in a set of possible payers, which the system 100 reduces to a multi-class classification task.

The inputs to train the CNN 202 classifier (e.g. classification 196 of FIG. 5) are the labels of the payers (e.g. insurance payers such as Blue Shield, Humana, Cigna, Aetna, etc.) and the raw images 174 of the insurance cards 102. Similar to the CNN 176, the CNN 202 can leverage a LeNet style architecture with alternating convolution and pooling layers (e.g. 178, 180 of FIG. 5) followed by several fully connected layers and a final layer (e.g. 197) whose number of neurons is equal to the total number of payers, with a softmax activation function to calibrate the probabilities corresponding to each class. In this way, a most payer can be determined for a given insurance card 102.

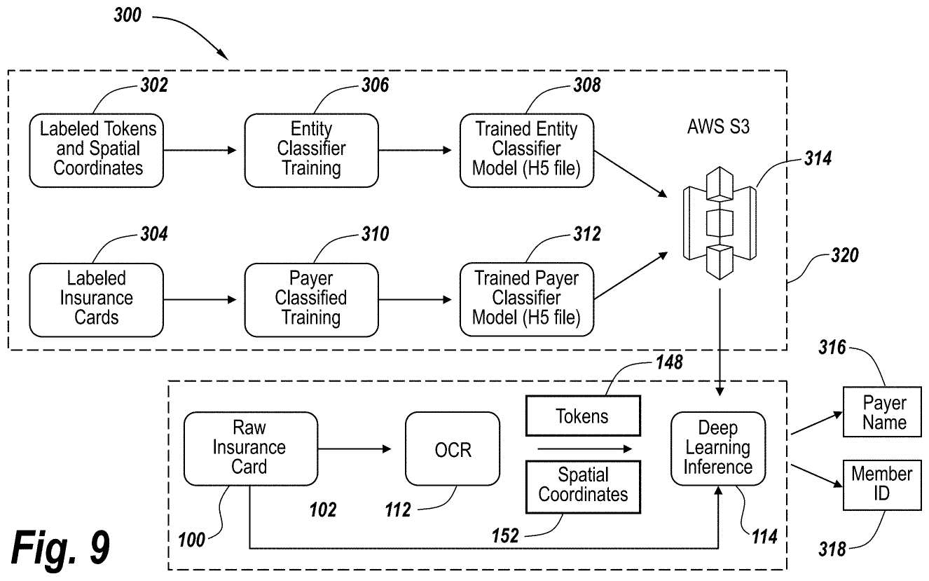

While the final system 100 to be used by the client is shown in FIG. 1, it is important to note that model training and creation will be used to build the deep learning components of the system 100 and allowing the system 100 to accurately make predictions related to the information shown on a scanned insurance card 102. As such, referring now to FIG. 9, a block diagram is shown of a system 300, which includes the training process for the system 100. The system 300 begins with an untrained (initialized) neural network and a training dataset containing labeled tokens 302 and labeled images 304 of the insurance card 102. The labeled tokens 302 are utilized in an entity classifier training module 306 to generate a trained entity classifier model 308. The labeled insurance images 304 are utilized in a payer classifier training module 310 to generate a trained payer classifier model 312.

For all the above methods that use neural networks, includes RNNs, CNNs, GNNs, and the like, the training is performed via a gradient descent procedure in which parameter updates are made by computing the gradients of the loss function (cross entropy in this case), with respect to the trainable parameters of the neural network. Initialization of neural network parameters can be done through a variety of techniques including but not limited to random normal, Glorot normal, Glorot uniform, and He normal.

The systems 100, 300 continue to learn as new insurance cards are processed. As patients continue to receive indications of their information, as identified by the systems 100, 300, patients can confirm whether or not that information is correct, helping the systems 100, 300 determine whether entities extracted from the insurance cards were accurate.

In brief summary, as with known machine learning system, the process of system 300 is decomposed into a training phase and a validation phase. The system 300 splits the dataset of images into a training set, consisting of 80% of the total images in the set. 10% of the images are a validation set and 10% of the images are a test set. The neural network is fitted to the training dataset and ultimately measures the performance generalization on the testing set. The system 300 leverages the validation set to adjust neural network hyperparameters which include but are not limited to: number of hidden layers; choice of activation function (including sigmoid, tanh, ReLU, etc.); Wright initialization function; optimizer function (including Adam, stochastic gradient descent (SGD), etc.); and number of epochs (iterations through the entire training set).

While there exist a number of software libraries which assist in the training and deployment of neural networks, one software library that has been found to be advantageous is Tensorflow 2.0 (Google's neural network library), which contains the API needed to construct custom neural networks, train them, and save the models for downstream inference (e.g. within deep learning module 114). The deep learning inference server 320 of the system 300 performs inference on multimodal outputs, which came from the OCR system, including the extracted tokens and spatial information in addition to the raw image itself. The responsibility of the server 320 is to take in the outputs of the OCR and the raw image, and produce a final prediction for the extracted entity of interest by performing inference using both the entity extraction model 308 and the payer extraction model 312. Both models, as outlined above, are neural networks that are persisted in a form of cloud storage 314 that is accessible to this server 320. In one implementation, the system 300 can use AWS S3 distributed file storage for the storage 314 of the models.

Overall, the flow of information using the systems 100, 300 described herein, in and out of the deep learning inference pipeline, can be defined as follows. First, entity classification and payer classification neural networks from cloud storage (AWS S3) 314 are loaded into memory using the Tensorflow library. Next, a JSON formatted output of the OCR pipeline is taken on which contains the extracted tokens from the image, as well as the spatial information from which a relative Cartesian coordinate can be derived. Next, inference is performed in parallel on each token to receive a member ID score using the entity classification model (RNN based). From that, the token with the maximum member ID score is identified as the predicted member ID 318. Alternatively or additionally, other information from the insurance card can be similarly scored, such as patient name, date of birth, insurance policy type, etc. Next, inference is performed on the raw image of the insurance card using the payer classification model (CNN) to identify a payer name 316 (e.g. an insurance payer). Finally, a response (e.g. JSON response) is produced containing the predicted entities. As such, one or more insurance cards can be automatically processed by the system to gather all necessary data, including member ID 318 and payer name 316.

In brief summary, the systems 100, 300 provide a number of useful solutions and advantages over known systems. As described herein, OCR is used to extract text tokens and their bounding boxes to serve as multimodal input into deep learning models. RNN and variants are used to model entity extraction as sequence classification on top of the OCR system, in which both the raw sequence and spatial orientation are considered. RNN variants including LSTMs, GRUS, and bidirectional variants, in addition to transformer architectures are described to enhance performance. Distance between the corners of bounding boxes associated with text tokens is used to determine edges between the nodes of the graph which sets the topology for message passing in a GNN. A hybrid RNN and GNN solution is described in which the high dimensional output from the RNN hidden state is used as the representation for a node in a discrete graph and dictates the creation of the GNN feature matrix. The whole constructed discrete graph is used with a GNN, or alternative such as GCN or GAT, to determine latent representations for the nodes in a supervised fashion. The latent representations of nodes are used to determine the nature of text tokens (i.e. if they are tokens of interest such as patient member ID, patient name etc. or otherwise), and this can be flexibly adjusted to any entity of interest on the insurance card using the same methodology. The raw pixels are subject to a CNN to build a representation of an insurance card from raw pixels which is then used to determine useful information such as the payer name the card is associated with, to complement the entity extraction approaches outlined above. In this way, the systems 100, 300 described herein provide an effective system and process for extracting information from insurance cards, allowing member patients to have their relevant insurance information entered into a database by simply taking a picture of their insurance card.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend on any or all claims in a multiple dependent manner even though such has not been originally claimed.

What is claimed is:

1. A system for processing a plurality of images of insurance cards to extract entities, comprising at least one computer-readable medium storing instructions, which, when executed:
process the images of the insurance cards using OCR to identify characters on the insurance cards and relative spatial orientation of said characters to determine a plurality of tokens and a spatial orientation of said tokens, the tokens representing possible combinations of identified characters on the insurance card;
determine coordinates for each token on the insurance card based on the spatial orientation of the tokens, the tokens and coordinates representing an OCR output;
generate a fully connected neural network including a node for each token based on the images of the insurance cards and the OCR output;
scoring each node with a member ID score for the likelihood that said node corresponds to a member ID on the insurance card; and
identifying, on each insurance card, a member ID for said insurance card based on the node with the highest member ID score.

2. The system of claim 1, wherein generating the fully connected neural network includes modeling the OCR output for each insurance card by using vector representations of each token.

3. The system of claim 1, wherein:
generating the fully connected neural network includes generating a graph based on the OCR output for each insurance card, with each token for said insurance card taken as a node of the graph and edges being declared when Euclidean distance is below a given threshold, wherein a node feature matrix is constructed based on the graph; and
scoring each node is based, at least in part, on the node feature matrix.

4. A system for processing a plurality of insurance cards, comprising:
a camera configured to capture a plurality of images, the images including one image corresponding to each one of the insurance cards;
at least one computer configured, for each insurance card, to:
process the image of the insurance card using OCR to identify characters on the insurance card and relative spatial orientation of said characters to determine a plurality of tokens and a spatial orientation of said tokens, the tokens representing possible combinations of identified characters on the insurance card;
determine coordinates for each token on the insurance card based on the spatial orientation of the tokens;
execute a first processing step based on a first recurrent neural network (RNN), or RNN variant, to model the OCR output for each insurance card, using vector representations of each token to obtain a logit for each token;
execute a second processing step based on a graph neural network (GNN), or GNN variant, including generating embeddings based on an RNN output from the first RNN, the embeddings being vector representations of the tokens, and using the embeddings and the OCR output to generate a graph, with each token as a node, to construct a node feature matrix;
execute a third processing step using a hybrid convolutional neural network (CNN), the hybrid CNN processing the image of each insurance card with a CNN to generate an image representation of each insurance card and combining each image representation with a hidden output from the first RNN;
execute a fourth processing step using a second RNN, or RNN variant, the second RNN modeling the OCR output using a fixed length vector from the image of the insurance card; and
extract at least one entity from each insurance card based on the processing steps by assigning a score to the tokens based on a likelihood that the token corresponds to an expected characteristic, the expected characteristics including at least a member ID.

5. The system of claim 4, wherein, when executing the second processing step, edges define connections between nodes on the graph when a Euclidean distance between said nodes exceeds a predetermined threshold.

6. The system of claim 4, wherein:
each processing step generates at least one logit for each token correlating said token to with one of a plurality of expected characteristics; and
during the step of extracting the at least one entity, the score for each entity is assigned to each token based on the logits correlating said token to one of the expected characteristics.

7. The system of claim 4, wherein the at least one computer is further configured to train the system during the processing steps by executing the processing steps on insurance cards comprising:
a first group of insurance cards representing a validation set; and
a second group of insurance cards representing a training set.

8. The system of claim 4, wherein;
the at least one computer further includes a database of predetermined payer labels;
and, for each insurance card, the system determines a payer associated with said insurance card by processing the image of said insurance card and ranking a likelihood of each payer based on the database of predetermined payer labels.

9. The system of claim 8, wherein the system determines the payer with the CNN during execution of the third processing step.

10. The system of claim 4, wherein the system is further configured to generate a database of information for a plurality of members each associated with one of the insurance cards, the database registering one member for each insurance card and including at least a name and member ID for each member based on the entities extracted for said insurance card.

11. The system of claim 4, wherein the expected characteristics further include one or more of the following:
a name; and
an insurance company.

12. The system of claim 4, wherein, during execution of the second processing step, hybrid backpropagation is used to train the GNN and RNN collaboratively.

13. The system of claim 4, wherein, during execution of the third processing step, the CNN and first RNN are joined and the parameters of the CNN and first RNN are updated simultaneously to optimize train the hybrid CNN.
